(19) United States
(12) Patent Application Publication
(10) Pub. No.: US 2005/0276935 A1
(43) Pub. Date: Dec. 15, 2005

(54) Ink-jet recording medium

(75) Inventors: Yuzo Toda, Goirle (NL); Yoichiro Kamiyama, Tilburg (NL); Antonius Petrus M. van der Pluijm, Raamsdonkveer (NL); Bernadette Catharina A.M. van der Velden-Schuermans, Udenhout (NL); Iskandar Gandasasmita, Tilburg (NL)

Correspondence Address: BANNER & WITCOFF, LTD., 28 STATE STREET, 28th FLOOR, BOSTON, MA, 02109-9601, US

(73) Assignee: Fuji Photo Film B.V., Tilburg (NL)

(21) Appl. No.: 11/143,113

(22) Filed: Jun. 2, 2005

Related U.S. Application Data
(63) Continuation of application No. PCT/NL03/00855, filed on Dec. 3, 2003.

(30) Foreign Application Priority Data
Dec. 4, 2002 (EP) 02080108.0

(51) Int. Cl. B41M 5/00

(52) U.S. Cl. 428/32.34

(57) ABSTRACT

The present invention relates to a recording medium, in particular an ink-jet recording medium of photographic quality that has excellent ink absorption speed, good drying characteristics, and a good image printing quality. According to the present invention, an ink-jet recording medium is provided, comprising a support to which a (micro-)porous, water-swellable layer is adhered. The present invention is further directed to methods for obtaining such a medium.

### FIELD OF INVENTION

The present invention relates generally to a recording medium, in particular an ink-jet recording medium of photographic quality that has excellent ink absorption speed, good drying characteristics and a good image printing quality.

### BACKGROUND OF THE INVENTION

In a typical inkjet recording or printing system, ink droplets are ejected from a nozzle at high speed towards a recording element or medium to produce an image on the medium. The ink droplets, or recording liquid, generally comprise a recording agent, such as a dye, and a relatively large amount of solvent in order to prevent clogging of the nozzle. The solvent, or carrier liquid, typically is made up of water, and organic material such as monohydric alcohols and the like. An image recorded as liquid droplets requires a receptor on which the recording liquid dries quickly without running or spreading. High quality image reproduction using ink-jet printing techniques requires receptor substrates, typically sheets of paper or opaque or transparent film, that readily absorb ink droplets while preventing droplet diffusion or migration. Good absorption of ink encourages image drying while minimizing dye migration by which good sharpness of the recorded image is obtained.

There are in general two approaches for producing inkjet recording media with photographic quality and good drying properties.

One known approach is to provide a substrate with a porous layer, which can act as the ink-receiving layer. However, this known technique may give problems as to the gloss of the paper. In a specific embodiment of the known substrates provided with a porous layer, there is provided on top of the support a microporous ink-receiving layer. In this microporous type, the microporous film has as the primary function to absorb the ink solvent. The typical microporous film suitable for this purpose is described inter alia in U.S. Pat. No. 4,833,172, U.S. Pat. No. 4,861,644, U.S. Pat. No. 5,326,391 and EP-A-204 778.

Another approach for producing inkjet recording media with photographic quality and good drying properties is the so called “non-microporous film type” as proposed in several patent publications such as EP-A-806 299 and JP-A-22 76 670. For this type of ink-jet recording medium, at least one ink receptive layer is coated on a support such as a paper or a transparent film. The ink receptive layer typically contains various proportions of water-swellable binders and fillers. The proportions of these components affect the properties of the coatings, in particular ink absorption properties and the gloss quality appearance of the ink-jet media.

One of the important properties of an ink-jet receptive coating formulation is the liquid absorptivity. The majority, if not all, of the ink solvent has to be absorbed by the coating layer itself. Only when paper or cloth or cellulose is used as a support, some part of the solvent may be absorbed by the support. It is thus obvious that both the binder and the filler should have a significant ability to absorb the ink solvent.

One way to improve the liquid absorption and drying rates is the use of water-swellable polymers. DE-A-223 48 23, and U.S. Pat. No. 4,379,804 disclose methods in which gelatin is used in ink-receiving layers of ink-jet receiving sheets. From these documents, it has become clear that gelatin has an advantageous function for the absorption of ink solvents. The gelatin is said to improve smudge resistance and to increase the definition quality.

U.S. Pat. No. 5,804,320 discloses a receiving medium, which comprises an ink-receiving layer comprising a pigment and an alkali-processed gelatin, wherein said gelatin has no sol-gel reversibility at room temperature and has an average molecular weight within the range from 50 000 to 150 000. High image density and resolution, sharp colour tone and good ink absorptivity are obtained.

U.S. Pat. No. 2002/142141 discloses an image-receiving layer, which may contain at least one swellable polymer like polyvinyl alcohol. Improved performance with respect to durability, scuff resistance and image fidelity is obtained.

In EP-A-875 393 a sheet for ink-jet recording is disclosed in which microporous polysaccharide particles are provided in an ink receiving layer comprising for example polyvinyl alcohol. The microporous particles give very good ink receptivity and also provide good sheet feeding property in ink-jet printers.

In EP-A-1 080 937 an ink-receiving sheet is described having improved glossiness by the use of polysaccharides in combination with gelatin or gelatin derivatives.

U.S. Pat. No. 5,723,211 describes an ink-jet printer-recording element comprising a substrate, a solvent absorbing gelatin layer and an ink-receiving layer. Good drying, high optical densities good water fastness and excellent off set and smut resistance is claimed.

When comparing both solutions for providing an ink-jet recording medium: medium with a microporous layer or medium with a water-swellable layer, both solutions have their positive and negative characteristics.

On the one hand, the microporous ink-jet recording media have excellent drying properties, but generally suffer from dye fading. On the other hand the swellable type of ink-jet recording media may give less dye fading, but these generally dry more slowly.

There remains a need for ink-jet recording media having excellent drying properties and which show minimal dye fading. In addition, these ink-jet recording media should preferably have properties such as suitable durability, good sheet feeding property in ink-jet printers, good image density, as well as a good resolution.

It is towards fulfilling this need that the present invention is directed.

### SUMMARY OF THE INVENTION

The object of the present invention is thus to provide an ink-jet recording medium having good drying properties, said recording medium more in particular being suited to produce images of photographic quality. It is another object of this invention to provide an ink-jet recording medium having good drying characteristics. It is yet another objective of this invention to provide an ink-jet recording medium having excellent dye fading resistance.

It has been found that these objectives can be met by providing an ink-jet recording medium comprising a porous water-swellable ink receiving layer, in particular a microporous water-swellable ink receiving layer. Accordingly, the present invention is directed to an ink-jet recording medium comprising a support, and a porous water-swellable ink receiving layer, adhered to said support. The porous water-swellable ink receiving layer may be characterized by:
a water-swellable polymer;
pores/voids, preferably having a void volume between 1 to 80 volume percent of the ink receiving layer, more preferably from 5 to 70 vol. %;
optionally containing additives and reagents to improve the ink receiving layer properties with respect to ink receptivity, strength and surface appearance;
optionally a permeable protective coating provided on top of said porous swellable layer.

The porosity in the ink-receiving layer of the media of the present invention is thus provided by voids which may be e.g. the result of gas bubbles present in the polymer solution when preparing the water-swellable ink-receiving polymer layer. This is in contrast with the prior art media, according to which the porosity is obtained by using porous filler particles. Thus the walls of a substantial part of the pores or voids (typically the majority of the pores or voids, e.g. 80% or more) in the media of the present invention are formed by the water-swellable polymer of the ink-receiving layer, rather than by the material of porous filler particles, as would be the case in the prior art media. Naturally the presence of (porous) filler particles is not excluded in the present invention.

The substrate used in the ink-jet receiving sheet of the present invention includes a conventional substrate for ink-jet receiving sheet. A transparent or opaque support can be used according to its final intended use.

The water-swellable polymer can be any water-swellable polymer known in the art. Preferably gelatin, gelatin derivatives or polyvinyl alcohol is used for this purpose.

Upon our investigations to improve the drying properties of the water-swellable ink receiving layers, we surprisingly found that incorporation of voids or pores in the water-swellable polymer layer improved the drying properties significantly, while all the advantages of the prior art with respect to water-swellable ink receiving layers are maintained. Surprisingly, it was found that it is possible to introduce voids in a water-swellable layer. The prior art microporous layers are all composed of hydrophilic inorganic voided layers, or layers containing porous fillers/pigments. Water-swellable ink receiving layers including voids are not known in the art. Only a few examples are known of incorporating voids in water-swellable polymers, which are in different fields of technology, viz. not in the field of ink-jet media. For example, gelatin layers comprising voids are known from U.S. Pat. No. 5,360,828, which describes a bio foam from gelatin, in which a gelatin solution in water is made. This solution is solidified and the water is replaced by organic solvents. After evaporation of these solvents, a gelatin foam remains. Another method of introducing voids in gelatin structures is described in U.S. Pat. No. 4,954,381. In this document, a method is described to make a microporous structure by mixing a solution of a water soluble polymer A with an organic solvent solution of a polymer B, in which polymer A and B can react with each other and evaporating the organic solution. These patent documents describe the use of these materials as insulating material or membranes.

The present invention is furthermore directed to a method for preparing inkjet recording media having a porous ink-receiving water-swellable layer, which method comprises introducing voids in the swellable ink-receiving layer. According to one embodiment of the process of the present invention first a homogeneous formulation of the ink-receiving layer comprising the water-swellable polymer is made. This means, that one or more pigments, surfactants, cross linking agents, plasticisers, fillers and the like (insofar these are used), are added to the solution in water of the water-swellable polymer. After a homogeneous mixture is reached by stirring, an organic solvent is introduced. This organic solvent can be any solvent, which is basically not miscible with water and has a boiling point preferably below 100° C. One can use very apolar solvents like hexane or pentane, but preferably a solvent like ethyl acetate is used. Also solvent mixtures can be used. These organic solvents can comprise agents to adjust the mixing with water and/or to modify the ink receptivity of the formed ink-receiving layer. The aqueous mixture and the organic solution are mixed e.g. under high shear, such that a dispersion is made.

Next, this dispersion is coated on a substrate. Very high coating speeds can be used compared with the speeds, which are used in applying a thick boehmite ink-receiving layer on a substrate. The coating of the resulting coated material is solidified by cooling and the resulting coated material is dried. The resulting sheet has excellent properties as ink-jet recording medium. In the course of solidifying, the organic solvent will evaporate. The voids left by the solvent provide for the porous structure of the media of the present invention. Optionally, the coated material can be heated and/or subjected to reduced pressure so as to facilitate evaporation of the organic solvent.

In another embodiment of this invention the porous water-swellable ink receiving layer is made by directly introducing gas bubbles into the homogeneous formulation of the ink receiving layer in water, coating this formulation on a substrate and drying the resulting sheet.

Optionally an ink permeable protective coating is supplied on top of the coated material to strengthen the resistance of the coated material towards physical impact.

### DETAILED DESCRIPTION

The present invention is directed to an inkjet recording medium comprising a support, and a porous water-swellable ink receiving layer, adhered to said support; as well as to methods for producing such a medium and methods for printing on this medium.

The voids in the recording media of the present invention may be introduced therein by several methods. For instance, the voids may result from droplets of a liquid that is poorly miscible with the solution of the material from which the water soluble layer is made. By subsequently removing the poorly miscible liquid, while the material forming the water soluble layer is allowed to maintain its shape, a porous water swellable layer may be obtained. Alternatively or in addition, the pores may be created in the layer by starting from solid particles and/or gas generating compounds (such as certain salts) as will be disclosed in more detail herein below. In one embodiment the recording medium of this invention is produced by:
1. Making a homogeneous aqueous mixture of a water soluble polymer, and one or more optional ingredients, such as pigments, surfactants, cross linking agents, plasticisers, fillers, etc.;
2. Preparing a formulation comprising at least one organic solvent, which organic solvent is water immiscible or very poorly water miscible;
3. Mixing the aqueous mixture and the organic formulation, typically under high shear, giving a dispersion of the organic solution in the aqueous mixture;
4. Coating this dispersion on a substrate and drying the resulting coated material;
5. Optionally, applying a protective coating, preferably in the same coating process step of applying the dispersion or in a separate coating step.

In another embodiment of the present invention the recording medium is produced as follows:
1. Making a homogeneous aqueous mixture of a water soluble polymer, optionally containing one or more of pigments, surfactants, cross linking agents, plasticisers, fillers and the like;
2. Introducing gas bubbles in this homogeneous aqueous mixture;
3. Coating the resulting dispersion on a substrate and drying the resulting coated material;
4. Optionally, applying a protective coating in the same coating process step of applying the dispersion or in a separate coating step.

The homogeneous aqueous mixture, which is used in both of the above-mentioned methods comprises, apart from water, a polymer, which is soluble in water. Water soluble polymers suitable for this purpose include homo polymers and copolymers such as, polyvinyl pyrrolidone, hydroxyethyl cellulose, hydroxypropyl cellulose, hydroxypropylmethyl cellulose starches, polyethylene oxide, polyacrylamides, gelatin, gelatin derivatives, polyvinyl alcohol and the like. Also mixtures of these and other homo polymers and copolymers can be used.

Polyvinyl alcohol, gelatin and modified gelatins are preferred. There is a variety of gelatins or modified gelatins, which can be used. For example: alkali-treated gelatin (cattle bone or hide gelatin) or acid-treated gelatin (pigskin gelatin), gelatin derivatives, like acetylated gelatin, phthalate gelatin and the like. These gelatins can be used singly or in combination for forming the solvent-absorbing layer used in the image-recording elements of the present invention.

The water-soluble polymers in the porous water-swellable ink receiving layer(s) are preferably used in a total amount of from 1 to 30 g/m², and more preferably from 2 to 20 g/m². When preparing the inkjet-receiving sheet by coating a plurality of ink receiving layers, each ink-receiving layer comprises typically an amount of gelatin ranging from 0.5 to 10 g/m².

If desired, the water-soluble polymers can be cross-linked in the image-recording elements of the present invention in order to impart mechanical strength to the layer. This can be done by any cross-linking agent known in the art.

For gelatin, there are a vast number of known cross-linking agents-also known as hardening agents. Examples of the hardener include aldehyde compounds such as formaldehyde and glutaraldehyde, ketone compounds such as diacetyl and chloropentanedion, bis (2-chloroethylurea), 2-hydroxy-4, 6-dichloro-1,3,5-triazine, reactive halogen-containing compounds disclosed in U.S. Pat. No. 3,288,775, carbamoyl pyridinium compounds in which the pyridine ring carries a sulphate or an alkyl sulphate group disclosed in U.S. Pat. No. 4,063,952 and U.S. Pat. No. 5,529,892, divinylsulfones, and the like. These hardeners can be used singly or in combination. The amount of hardener used, preferably ranges from 0.1 to 10 g, and more preferably from 0.15 to 7 g based on 100 g of gelatin contained in the ink-receiving layer.

The homogeneous aqueous mixture may further contain one or more surfactants. Preferred examples of surfactants include anionic surfactants, amphoteric surfactants, cationic surfactants, and non-ionic surfactants.

Examples of anionic surfactants include alkylsulfocarboxylates, alpha olefin sulfonates, polyoxyethylene alkyl ether acetates, N-acylaminoacids and salts thereof, N-acylmethyltaurine salts, alkylsulphates, polyoxyalkylether sulphates, polyoxyalkylether phosphates, rosin soap, castor oil sulphate, lauryl alcohol sulphate, alkyl phenol phosphates, alkyl phosphates, alkyl allyl sulfonates, diethylsulfosuccinates, diethylhexylsulfosuccinates, dioctylsulfosuccinates and the like.

Examples of the cationic surfactants include 2-vinylpyridine derivatives and poly-4-vinylpyridine derivatives.

Examples of the amphoteric surfactants include lauryl dimethyl aminoacetic acid betaine, 2-alkyl-N-carboxymethyl-N-hydroxyethyl imidazolinium betaine, propyldimethylaminoacetic acid betaine, polyoctyl polyaminoethyl glycine, and imidazoline derivatives.

Useful examples of non-ionic surfactants include non-ionic fluorinated surfactants and non-ionic hydrocarbon surfactants. Useful examples of non-ionic hydrocarbon surfactants include ethers, such as polyoxyethylene nonyl phenyl ether, polyoxyethylene octyl phenyl ether, polyoxyethylene dodecyl phenyl ether, polyoxyethylene alkyl allyl ethers, polyoxyethylene oleyl ethers, polyoxyethylene lauryl ethers, polyoxyethylene alkyl ethers, polyoxyalkylene alkyl ethers; esters, such as polyoxyethylene oleate, polyoxyethylene distearate, sorbitan laurate, sorbitan monostearate, sorbitan monooleate, sorbitan sesquioleate, polyoxyethylene monooleate, polyoxyethylene stearate; glycol surfactants and the like. The above-mentioned surfactants are preferably added to the homogeneous aqueous mixture in an amount ranging from 0.1 to 1000 mg/M², preferably from 0.5 to 100 mg/M².

The homogeneous aqueous mixture may further comprise one or more of the following ingredients:

One or more matting agents such as titanium dioxide, zinc oxide, silica and polymeric beads such as cross linked poly (methyl methacrylate) or polystyrene beads for the purposes of contributing to the non-blocking characteristics of the recording elements used in the present invention and to control the smudge resistance thereof. These matting agents may be used alone or in combination

One ore more plasticizers, such as ethylene glycol, diethylene glycol, propylene glycol, polyethylene glycol, glycerol monomethylether, glycerol monochlorohydrin, ethylene carbonate, propylene carbonate, tetrachlorophthalic anhydride, tetrabromophthalic anhydride, urea phosphate, triphenylphosphate, glycerolmonostearate, propylene glycol monostearate, tetramethylene sulfone, N-methyl-2-pyrrolidone, N-vinyl-2-pyrrolidone, and polymer lattices with low Tg-value such as polyethylacrylate, polymethylacrylate, etc.

One or more fillers; both organic and inorganic particles can be used as fillers. Useful filler examples are represented by silica (colloidal silica), alumina or alumina hydrate (aluminazol, colloidal alumina, a cation aluminium oxide or its hydrate and pseudo-boehmite), a surface-processed cation colloidal silica, aluminium silicate, magnesium silicate, magnesium carbonate, titanium dioxide, zinc oxide, calcium carbonate, kaolin, talc, clay, zinc carbonate, satin white, diatomaceous earth, synthetic amorphous silica, aluminium hydroxide, lithopone, zeolite, magnesium hydroxide and synthetic mica. Among these inorganic fillers, porous inorganic fillers are preferable such as porous synthetic silica, porous calcium carbonate and porous alumina. Useful examples of organic fillers are represented by polystyrene, polymethacrylate, polymethyl-methacrylate, elastomers, ethylene-vinyl acetate copolymers, polyesters, polyester-copolymers, polyacrylates, polyvinylethers, polyamides, polyolefines, polysilicones, guanamine resins, polytetrafluoroethylene, elastomeric styrene-butadiene rubber (SBR), urea resins, urea-formalin resins. Such organic and inorganic fillers may by used alone or in combination.

One or more mordants. Mordants may be incorporated in the ink-receptive layer of the present invention. Such mordants are represented by cationic compounds, monomeric or polymeric, capable of complexing with the dyes used in the ink compositions. Useful examples of such mordants include quaternary ammonium block copolymers. Other suitable mordants comprise diamino alkanes, ammonium quaternary salts and quaternary acrylic copolymer latexes. Other suitable mordants are fluoro compounds, such as tetra ammonium fluoride hydrate, 2,2,2-trifluoroethylamine hydrochloride, 1-(alpha, alpha, alpha -trifluoro-m-tolyl) piperazine hydrochloride, 4-bromo-alpha, alpha, alpha -trifluoro-o-toluidine hydrochloride, difluorophenylhydrazine hydrochloride, 4-fluorobenzylamine hydrochloride, 4-fluoro- alpha, alpha -dimethylphenethylamine hydrochloride, 2-fluoroethylaminehydrochloride, 2-fluoro-1-methyl pyridinium-toluene sulfonate, 4-fluorophenethylamine hydrochloride, fluorophenylhydrazine hydrochloride, 1-(2-fluorophenyl) piperazine monohydrochloride, 1-fluoro pyridinium trifluoromethane sulfonate.

One ore more conventional additives, such as:
pigments: white pigments such as titanium oxide, zinc oxide, talc, calcium carbonate and the like; blue pigments or dyes such as cobalt blue, ultramarine or phthalocyanine blue; magenta pigments or dyes such as cobalt violet, fast violet or manganese violet;
Biocides;
pH controllers,
preservatives;
viscosity modifiers;
dispersing agents;
UV absorbing agents;
brightening agents;
anti-oxidants; and/or
antistatic agents.

These additives may be selected from known compounds and materials in accordance with the objects to be achieved.

The above-mentioned additives (matting agents, plasticizers, fillers/pigments, mordants, conventional additives) may be added in a range of 0 to 30% by weight, based on the solid content of the water-swellable ink receiving layer composition.

The particle sizes of the non-water soluble additives should not be too high, since otherwise a negative influence on the resulting surface will be obtained. The used particle size should therefore preferably be less than 10 μm, more preferably 7 μm or less. The particle size is preferably above 0.1 μm, more preferably about 1 μm or more for handling purposes.

The organic solvent solution used in the present invention is used to introduce droplets in the aqueous mixture., which after evaporation of the solvent will give voids, creating a porous structure. More in particular, after coating the aqueous mixture comprising the organic solvent droplets, the coating is jellified through chilling. From this gelled coating the solvents are evaporated. The evaporated organic solvent droplets leave voids behind, creating the porous structure. For this purpose in principle each organic solvent, which is not miscible with water, may be used. For practical reasons and ease of production it is preferred to select an organic solvent or organic solvent mixtures having a boiling point preferably below 150° C. but above approximately 40° C. When the boiling point of the organic solvent is below the boiling point of water the evaporation of the organic solvent is quick, and less voids can be formed. When the boiling point of the organic solvent is higher than the boiling point of water, the evaporation may be slow, but more voids can be formed. Although a phase separation between the organic solution phase and the aqueous phase is essential for the present invention it is also a requirement that the resulting dispersion should be stable long enough to apply the homogeneous dispersion onto a substrate. It is therefore not preferable to use very apolar solvents as phase separation will be very quick and it will become difficult to apply a homogeneous dispersion to the substrate. Most preferably, organic solvents or solvent mixtures are used having a water solubility at 25° C. which is between 1 and 10 mass %, more preferably between 2 and 8 mass %. Most preferred solvents include: ethyl acetate, butyl acetate, ethyl propionate, methyl ethylketone, and the like and mixtures of these solvents.

The organic solvent solution further may comprise in the solvent soluble polymers such as cellulose derivatives, polyacrylates and derivatives. Also polyvinyl acetate or partly hydrolysed polyvinyl acetate may be used. These polymers are present in an amount from 0 to 30% and may be used to stabilize the formed voids.

In order to prepare stable dispersions, also surfactants known in the art, and which are soluble in the organic solutions, can be added.

Both the homogeneous aqueous dispersion and organic solvent solution are preferably mixed under high shear. Preferred weight ratios of aqueous dispersion/organic solution are from 10/1 to 1/1, more preferably between 6/1 to 1.1/1.

The aqueous mixture and the organic solvent solution are emulsified typically using high shear. Suitable apparatuses include a colloid mill, a homogeniser, a porous emulsifier/fluidiser, an electro magnetic strain type ultrasonic generator, etc.

The resulting dispersion can be coated to a substrate by any method known in the art. The coating methods are for example, a curtain coating, an extrusion coating, an air-knife coating, a slide coating, a roll coating method, reverse roll coating, dip coating processes and a rod bar coating.

If desired, the porous water-swellable ink receiving layer of the present invention may be overcoated with an ink-permeable, anti-tack protective layer, such as, for example, a layer comprising a cellulose derivative such as hydroxymethyl cellulose, hydroxyethyl cellulose, hydroxypropyl methyl cellulose and carboxymethyl cellulose. An especially preferred topcoat is hydroxypropyl methylcellulose. The topcoat layer is usually non-porous, but is ink-permeable and serves to improve the optical density of the images printed on the element with water-based inks. The topcoat layer also serves to protect the porous, gelatin layer from abrasion, smudging and water damage.

The topcoat material is preferably coated onto the swellable polymer layer from water or water-alcohol solutions at a dry thickness ranging from 0.1 to 5.0 micrometers, preferably 0.5 to 2.0 micrometers. The topcoat layer may be coated in a separate operation or may be coated concurrently with the water-swellable layer.

In practice, one or more additives may be employed in the topcoat. These additives include surface active agents which control the wetting or spreading action of the coating mixture, anti-static agents, suspending agents, particulates which control the frictional properties or act as spacers for the coated product, antioxidants, UV-stabilizers and the like.

The support used in this invention may suitably be selected from a paper, a photographic base paper, a synthetic paper or a plastic film in which the top and back coatings are balanced in order to minimise the curl behaviour.

Examples of the material of the plastic film are polyolefins such as polyethylene and polypropylene, vinyl copolymers such as polyvinyl acetate, polyvinyl chloride and polystyrene, polyamide such as 6,6-nylon and 6-nylon, polyesters such as polyethylene terephthalate, polyethylene-2 and 6-naphthalate and polycarbonate, and cellulose acetates such as cellulose triacetate and cellulose diacetate. Before coating the dispersion onto the substrate, the substrate may be subjected to a corona treatment in order to improve the adhesion between the substrate and the coating. Also other techniques, like plasma treatment can be used to improve the adhesion.

After drying a porous water-swellable ink receiving layer is formed on top of the used substrate. The pores in this layer have a typical size ranging from 0.01 to 10 μm. Typically the mean (based on the total number of pores in the porous water-swellable layer) pore diameter is from 0.1 to 5 μm, more preferably from 0.2 to 1 μm. The porous water-swellable ink receiving layer has a dry thickness from typically 1 to 50 micrometers, preferably from 5 to 25 and more preferably between 8 and 16 micrometers. If the thickness of the solvent-absorbing gelatin layer is less than 1 micrometer, adequate absorption of the solvent will become difficult to be obtained. If, on the other hand, the thickness of the solvent-absorbing gelatin layer exceeds 50 micrometers, no further increase in solvent absorptivity will generally be gained.

In another embodiment of the present invention, the porous water-sweflable ink receiving layer is formed by directly incorporating gas bubbles in the aqueous dispersion, omitting the organic solvent addition step by which this embodiment is thus more environmental friendly. In this embodiment the aqueous homogeneous dispersion is made in the same way as described in the first embodiment.

After the aqueous homogeneous dispersion is made, bubbles are incorporated, for example by releasing pressure above the aqueous dispersion, which is supersaturated with gas.

Another method is to blow a gas under high shear in the homogeneous aqueous -dispersion. The gasses which can be used are the normal available cheap gases like air, nitrogen, carbon dioxide and the like, as well as mixtures thereof. If one would like to use other gases, like for example noble gases, this would also give good results, but economically this is not recommendable. The amount of incorporated gas is related to the amount of voids which one wants to achieve. An improvement in drying properties can already be obtained using a small amount of incorporated gas but most preferably an amount ranging from 5 to 80% on the total dry ink receiving layer volume should be used.

After the dispersion including a gas is formed, said dispersion is treated the same way as is mentioned in the embodiment of the process in which an organic solvent is applied. Also in this case the voids in the water-swellable porous layer have a diameter from 0.01 to 10 μm.

According to another embodiment of the present invention, voids are incorporated in the water-swellable ink receiving layer by providing a dispersion in water of a solid material, which solid material may be considered to serve as a template for said voids, said dispersion further comprising a dissolved water soluble polymer. Subsequently, the water is at least partly removed by drying and subsequently said solid template material is dissolved by a suitable solvent, thus leaving the voids in their desired number, shape and dimensions. More in particular, this method comprises for instance, preparation of an aqueous dispersion comprising a water soluble polyrner, a hardener and fine CaCO₃ powder (e.g. having a particle size <1 μm), coating said dispersion followed by drying it. After drying, the dried coated material is contacted with a diluted acidic solution (e.g. by immersing it therein). A suitable solution is a HCl solution e.g. with a pH ranging from 0-6. Thus the CaCO₃ is dissolved from the water swellable layer leaving the voids behind. Instead of CaCO₃ other inorganic compounds can be used, which are insoluble in water at a certain pH but which dissolve in water at a different pH. Examples are other Ca salts, Ba—, Zn—salts and the like. Suitable salts can be found in the literature (e.g. the CRC Handbook of Chemistry and Physics issued by CRC press LLC 81st Edition).

According to yet another embodiment of the present invention, voids are incorporated in a water-swellable ink receiving layer by using a gas releasing agent, in particular a solid gas releasing agent, viz a compound that can be converted into, or made to generate (e.g. by chemical reaction), a gas. Typically this embodiment involves preparing a first aqueous mixture comprising a hydrophilic polymer, a hardener for the hydrophilic polymer, the gas releasing agent (e.g. a salt, for example NaHCO₃) and optionally other components to adjust processability and image stability; preparing a second aqueous mixture comprising a pH adjusting agent, which provides a certain pH to said second mixture, which pH is chosen such that upon contact of the second mixture with said gas releasing agent the latter produces gas. For instance, for NaHCO₃ a pH between 0 and 6 can be used. Subsequently the first and second solution are coated successively or simultaneously on a substrate and dried to form the coating. The released gases will be captured in the gelled hydrophilic polymer. A good result is also obtained, when the gas releasing salt is dissolved in the mixture comprising the hydrophilic polymer and water at a pH just above the pH where gas releasing from the salt starts, coating the mixture and dry the coated material. During the drying the gas is released and voids are incorporated in the jellified hydrophilic polymer.

The present invention will be illustrated in detail by the following non-limiting examples.

### EXAMPLE 1 (COMPARATIVE)

An aqueous ink receiving layer involving the following process steps was prepared:
mixing a 15 g of acid processed gelatin with 85 g of water at room temperature, and leaving it for 90 minutes to allow gelatin to swell, then rising the temperature up to 60° C. to make it completely soluble by stirring,
adding biocide, wetting agent,
adjust pH to 7.5 by NaOH
adding viscosity modifier.

A photographic grade paper with polyethylene laminated (both sides) was used as a substrate. The surface was treated by corona to enhance the wettability.

Prior to applying onto the substrate, the coating liquid was adjusted with water to contain 10 wt % of gelatin.

The liquid was coated on the substrate by means of a KHand Coater, bar No. 5, with 150 μm wet thickness. The sheet was immediately cooled down to 6° C. in order to gelify the gelatin layer. After this the sheet was dried at 40° C. After drying the sheet was conditioned at 20° C. and 65% RH for at least 24 hours.

### EXAMPLE 2 (COMPARATIVE)

An aqueous ink receiving layer involving the following process steps was prepared:
mixing a 15 g of gelatin with 80 g of water at room temperature, and leaving it for 90 minutes to allow gelatin to swell, then rising the temperature up to 60° C. to make it completely soluble by stirring,
adding biocide, wetting agent,
adding 5 g of ethyl acetate as to form a uniform solution,
adjust pH to 7.5 by NaOH
the viscosity was about 70 mPa without adding a viscosity modifier.

An ink receiving sheet is produced according to the same steps as mentioned in Comparative Example 1.

### EXAMPLE 1

An aqueous ink receiving layer involving the following process steps was prepared:
mixing a 15 g of gelatin with 85 g of water at room temperature, and leaving it for 90 minutes to allow gelatin to swell, then rising the temperature up to 60° C. to make it completely soluble by stirring,
adding 50 g of ethyl acetate and 0.1 g TAYCAPOWER™ BC 2070M (emulsifying agent; TAYCA corporation, Japan), then stir to foam a coarse emulsion,
applying a shear to form a homogeneous emulsion by Microfluidizer model 110Y (Microfluidics corporation, USA), for 2 passes, at 4 bar,
adding biocide; wetting agent,
adjust pH to 7.5 by NaOH
the viscosity was about 70 mPa without adding a viscosity modifier.

The average size of the emulsion was about 0.3 μm in diameter.

An ink receiving sheet is produced according to the same steps as mentioned in Comparative Example 1.

### EXAMPLE 2

An aqueous ink receiving layer involving the following process steps was prepared:
mixing a 15 g of gelatin with 85 g of water at room temperature, and leaving it for 90 minutes to allow gelatin to swell, then rising the temperature up to 60° C. to make it completely soluble by stirring,
adding 50 g of ethyl acetate and 0.05 g of emulsifying agent TAYCAPOWER™ BC 2070M (TAYCA corporation, Japan), then stir to foam a coarse emulsion,
applying a shear to form a homogeneous emulsion by Microfluidizer model IOY (Microfluidics corporation, USA), for 1 passes, at 2 bar,
adding biocide; wetting agent,
adjust pH to 7.5 by NaOH
the viscosity was about 60 mPa without adding a viscosity modifier.

The average size of the emulsion was about 0.8 μm in diameter.

An ink receiving sheet is produced according to the same steps as mentioned in Comparative Example 1.

Printing Test & Dryness Evaluation of the Ink-Jet Media

The ink-jet sheets were further subjected to an ink-jet printing test. A standard pattern comprising the colours magenta, cyan, yellow, green, red, blue and black in 5 different densities was printed on the above mentioned substrates. The printers which were used herein were HP990cx.

Directly after printing the standard pattern, a white plain paper was overlaid on the printed sheet and a stainless steel roller with a weight of 10 kg was rolled over the white paper slowly. The drying speed of the ink-jet sheet was determined by analysing visually the colour density of the print which was transferred to the white paper. A lower density at the white paper means a better drying speed of the ink-jet solvent. The results of the printing test is given in table 1.

TABLE 1

| | Drying speed |
|---|---|
| Comparative Example 1 | X |
| Comparative Example 2 | Δ |
| Example 1 | O |
| Example 2 | Δ |

Definition
O = Good
Δ= Not totally dry but still acceptable
X = Bad (not acceptable)

1. Ink-jet recording medium comprising a support and a porous water-swellable layer adhered to said support.

2. Medium according to claim 1, wherein the majority of the porosity of said porous water-swellable layer is formed by voids, the walls of which voids are mainly formed by the material of said water-swellable layer.

3. Medium according to claim 1, wherein said porous water-swellable layer comprises a swellable hydrophilic polymer.

4. Medium according to claim 3, wherein said swellable hydrophilic polymer is selected from the group consisting of hydroxypropylmethylcellulose, polyvinyl pyrrolidone, hydroxyethyl cellulose, hydroxypropyl cellulose, starches, polyethylene oxide, polyacrylamides, gelatin, modified gelatin, polyvinyl alcohol and mixtures thereof.

5. Medium according to claim 1, wherein said layer comprises from 5 to 80% voids on the total volume of the swellable layer.

6. Medium according to claim 1, wherein said layer is microporous.

7. Medium according to claim 1, wherein said layer is microporous, comprising voids having a diameter from 0.01-10 μm.

8. Medium according to claim 1, further comprising an ink-permeable protective layer on top of said porous water-swellable layer.

9. Medium according to claim 8, wherein said protective layer comprises a compound selected from the group of hydroxypropyl methylcellulose, polyvinyl alcohol, gelatin, and mixtures thereof.

10. Medium according to claim 1, wherein said layer further comprises at least one additive selected from the group consisting of fillers, colorants, colored pigments, pigment dispersants, lubricants, permeating agents, fixing agents for ink dyes, LTV absorbers, anti-oxidants, dispersing agents, anti-foaming agents, levelling agents, fluidity improving agents, antiseptic agents, brightening agents, viscosity stabilizing and/or enhancing agents, pH adjusting agents, biocides, anti-mildew agents, antifungal agents, agents for moisture-proofing, agents for increasing the paper stiffness and anti-static agents.

11. Medium according to claim 10, in which said additive is water insoluble and has a size of between 0.1 and 10 μm.

12. Process for producing an inkjet recording medium according to claim 1, comprising the successive steps of
preparation of an aqueous formulation comprising water, at least one water-swellable material and optionally a hardening agent for said water-swellable material;
preparation of a formulation comprising at least one organic solvent;
mixing said aqueous formulation with the organic solvent formulation under high shear to obtain a dispersion of the organic solvent solution in the aqueous formulation; and
coating said dispersion on a substrate and drying said coated substrate and evaporating at least part of said organic solvent.

13. Process for producing an ink-jet recording medium according to claim 1, comprising the successive steps of
preparation of an aqueous formulation comprising water, at least one water-swellable material and optionally a hardening agent for said water-swellable material;
making a dispersion by incorporation a gas into the aqueous formulation; and
coating said dispersion on a substrate and drying said coated substrate.

14. Process according to claim 12, wherein the hardening agent is present in the amount of 0.1 to 10 g, based on 100 g of water-swellable material.

15. Process according to claim 12, wherein the aqueous formulation further comprises a surfactant.

16. Process according to claim 15, wherein the surfactant is selected from the group of non-ionic surfactants, anionic surfactants, cationic surfactants, amphoteric surfactants and mixtures thereof.

17. Process according to claim 16, wherein the surfactant is an anionic surfactant selected from the group consisting of alkylaryl sulphonates, alkyl sulphate ester, sulphosuccinic acid alkyl ester, aliphatic sulphonates, and mixtures thereof.

18. Process according to claim 15, wherein the surfactant is a cationic surfactant comprising quaternary ammonium compounds.

19. Process according to claim 15, wherein the amount of said surfactant is between 0.1 and 1000 mg/m², based on dry surfactant.

20. Process according to claim 12, in which one or more additives as defined in claim 10 are present in an amount of 0.5 to 30% of the total dry weight of said aqueous formulation.

21. Process according to claim 12 wherein said at least one organic solvent has a solubility in water from 1 to 10 mass %.

22. Process according to claim 21 in which said at least one organic solvent has a boiling point between 40° C. and 150° C.

23. Process according to claim 12, wherein said at least one organic solvent comprises further polymers, which are soluble in said at least one organic solvent.

24. Process according to claim 23 in which the further polymers are present from 0 to 30 weight % of the total organic solvent weight.

25. Process according to claim 12, wherein the organic solvent further comprises wetting agents.

26. Process according to claim 25, in which said wetting agent is present in amounts from 0 to 5 weight %.

27. Process according to claim 12, wherein the aqueous formulation and the organic solvent formulation are emulsified giving a dispersion of the organic solvent in the aqueous formulation using a suitable apparatus.

28. Process according to claim 12, wherein the weight ratio of aqueous formulation to organic solvent formulation is from 10:1 to 1:1.

29. Process according to claim 13, wherein the gas is dispersed in the homogeneous aqueous layer under high shear.

30. Process according to claim 13, wherein the gas is incorporated in the aqueous layer by the release of gas under a drop of pressure.

31. Process according to claim 29, wherein the gas is chosen from the group consisting of carbon dioxide, nitrogen, air and mixtures thereof.

32. Process according to claim 12, wherein said dispersion is coated on a substrate using curtain coating, extrusion coating, air-knife coating, slide coating, a roll coating method, reverse roll coating, dip coating processes and a rod bar coating and dried.

33. Process for producing an ink-jet recording medium, comprising the successive steps of:
preparation of an aqueous formulation comprising water, at least one water-swellable material and optionally a hardening agent for said water-swellable material;
admixing to said aqueous formulation one or more void generating compounds thus forming a dispersion of said one or more void generating compounds in said aqueous formulation;
coating said dispersion on a substrate, drying said coated substrate and converting said void generating compounds into voids.

34. Process according to claim 33, wherein said void generating compounds and said converting into voids are selected from the group consisting of
a formulation comprising at least one organic solvent and evaporating said organic solvent, respectively;
gas that is incorporated in said aqueous formulation and allowing the voids to be formed, respectively;
fine solid particles and dissolving said fine solid particles in a suitable solvent, followed by removing the solution thus formed, respectively;
a gas generating agent and reacting said gas generating agent with a compound to produce gas therefrom, respectively; and
combinations thereof.

35. Medium obtainable by the process of claim 12.

36. Medium according to claim 1, wherein said support is a paper, a photographic base paper, a synthetic paper or a film substrate.

37. Medium according to claim 36, wherein said substrate is corona treated before coating.

38. Medium according to claim 1, wherein said porous water-swellable layer has a thickness between 1 and 50 μm.

39. Medium according to claim 1. wherein said porous swellable layer has a thickness from 5-25 μm.

40. A method of forming a permanent, precise ink-jet image comprising the step of:
providing an ink-jet recording medium as is described in claim 1, and
introducing ink-jet ink into contact with the medium in the pattern of a desired image.

41. Medium according to claim 11, in which said additive is water insoluble and has a size of between 1 and 7 μm.

42. Process according to claim 12, wherein the hardening agent is present in the amount of 0.1 to 7 g, based on 100 g of water-swellable material.

43. Process according to claim 15, wherein the amount of said surfactant is between 0.5 and 100 mg/m², based on dry surfactant.

44. Process according to claim 27, wherein the suitable apparatus is a member selected from the group consisting of a colloid mill, a homogeniser, a microporous emulsifier/fluidiser, and an electro magnetic strain type ultrasonic generator.

45. Process according to claim 12, wherein the weight ratio aqueous formulation to organic solvent formulation is from 6:1 to 1.1:1.

46. Medium according to claim 1, wherein said porous swellable layer has a thickness from 8-16 μm.
